(19) United States
(12) Patent Application Publication
(10) Pub. No.: US 2016/0187105 A1
(43) Pub. Date: Jun. 30, 2016

(54) Camouflage Patterns

(71) Applicant: MCP IP, LLC, Sparta, WI (US)

(72) Inventor: Mathew A. McPherson, Norwalk, WI (US)

(21) Appl. No.: 14/997,766

(22) Filed: Jan. 18, 2016

Related U.S. Application Data
(63) Continuation of application No. 13/756,289, filed on Jan. 31, 2013.

(51) Int. Cl. F41H 3/00; G06T 11/60

(52) U.S. Cl. CPC F41H 3/00; G06T 11/60

(57) ABSTRACT

In some embodiments, a camouflage pattern comprises multiple layers of images, wherein at least one layer is provided at an opacity level that is less than the opacity of another layer. Camouflage patterns will mix images of various views and various amounts of transparency/opacity. In some embodiments, the opacity decreases with each successive layer. In some embodiments, opacity can decrease then increase. In some embodiments, a layer includes repeated images. In some embodiments, the orientation of various tiles change with respect to one another. The use of semi-transparent images layered to form a combination of patterns that are not found in nature constitute a unique and novel approach to camouflage product and method of development.

### BACKGROUND OF THE INVENTION

This disclosure relates to camouflage patterns, articles comprising camouflage patterns and methods of making camouflage patterns.

Camouflage is needed by the military and by private citizens. Concealment through camouflage is useful in many activities ranging from warfare to hunting to wildlife observation.

The initial military camouflage was a single color that masked the soldier with a color most similar to the surroundings, grey or tan. The advancements in camouflage technology brought color variations and shape variations to materials utilized for avoidance of observation. This disruptive pattern has been changed over the years in color tone and size of pattern with the use of digital imaging to blur the edges of the camouflage to provide a mottled pattern.

There remains a need for novel camouflage patterns and novel methods of creating camouflage patterns.

All US patents and applications and all other published documents mentioned anywhere in this application are incorporated herein by reference in their entirety.

Without limiting the scope of the invention a brief summary of some of the claimed embodiments of the invention is set forth below. Additional details of the summarized embodiments of the invention and/or additional embodiments of the invention may be found in the Detailed Description of the Invention below.

A brief abstract of the technical disclosure in the specification is provided as well only for the purposes of complying with 37 C.F.R. 1.72. The abstract is not intended to be used for interpreting the scope of the claims.

### BRIEF SUMMARY OF THE INVENTION

In some embodiments, a camouflage pattern is generated by layering images. In some embodiments, the images comprise captured images (e.g. a photographic image) and are non-distorted. In some embodiments, camouflage patterns can be made using multiple layers comprising images, wherein different images are provided with varying amounts of opacity. In some embodiments, images having differing levels of opacity are layered to form a pattern. Superimposing images allows for a mixture of images having various views, viewing angles and/or vantage points, and the combination of such images creates patterns that are not encountered in nature.

In some embodiments, multiple photographic layers having different opacities are combined. In some embodiments, a base layer is solid (e.g. 100% opacity) and non-base layers each have a reduced opacity when compared to the base layer. In some embodiments, a non-base layer has opacity in the range of 20% to 80% opacity. In some embodiments, the opacity decreases with each successive layer. In some embodiments, opacity can decrease then increase. In some embodiments, a layer includes repeated images. In some embodiments, the repeated images comprise a tiled layer wherein the repeating images have similar orientation. In some embodiments, the orientation of repeated images change with respect to one another.

A camouflage pattern may comprise any suitable number of layers. In some embodiments, a camouflage pattern comprises two layers. In some embodiments, a camouflage pattern comprises three layers. In some embodiments, a camouflage pattern comprises four layers. In some embodiments, a camouflage pattern consists of three layers. In some embodiments, a camouflage pattern consists of two layers.

The camouflage may be used for any suitable purpose, such as military or sporting purposes where concealment is desirable. In some embodiments, a realistic camouflage is intended to mask an individual or item in a natural environment. The use of various individual views/images that depict a natural environment, combined via novel layering and/or reduced transparency, presents a natural looking scenery comprising images that would not typically be encountered in nature from a single viewing angle/direction. Photographic camouflage patterns can be utilized to create visual confusion by breaking up the objects' outline through the use of natural images layered via superimposition techniques.

It is an object of the present invention to provide a method of producing patterns in perspective via photographic layering with variable transparency images.

The camouflage patterns disclosed herein can be applied to any suitable article, such as clothing, hunting accessories, vehicles, etc.

These and other embodiments which characterize the invention are pointed out with particularity in the claims annexed hereto and forming a part hereof. However, for a better understanding of the invention, its advantages and objectives obtained by its use, reference can be made to the drawings which form a further part hereof and the accompanying descriptive matter, in which there are illustrated and described various embodiments of the invention.

### BRIEF DESCRIPTION OF THE SEVERAL VIEWS OF THE DRAWING(S)

The foregoing and other objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 depicts an embodiment of an image suitable to be used as a layer in a camouflage pattern.

FIG. 2 depicts another embodiment of an image suitable to be used as a layer in a camouflage pattern.

FIG. 3 depicts an embodiment of a camouflage pattern comprising the layers shown in FIGS. 1 and 2.

FIG. 4 depicts another embodiment of an image suitable to be used as a layer in a camouflage pattern.

FIG. 5 depicts an embodiment of a camouflage pattern comprising the layers shown in FIGS. 4 and 2.

FIG. 6 depicts another embodiment of an image suitable to be used as a layer in a camouflage pattern.

FIG. 7 depicts an embodiment of a camouflage pattern comprising the layers shown in FIGS. 6, 2 and 4.

### DETAILED DESCRIPTION OF THE PREFERRED EMBODIMENTS

While this invention may be embodied in many different forms, there are described in detail herein specific embodiments of the invention. This description is an exemplification of the principles of the invention and is not intended to limit the invention to the particular embodiments illustrated.

In some embodiments, a camouflage pattern comprises multiple layers of images to create a novel pattern. In some embodiments, a camouflage pattern comprises one or more captured images, such as images that have been captured by a camera. In some embodiments, the images are not distorted in any way. In some embodiments, an image in at least one layer is distorted (e.g. stretched and/or skewed). In some embodiments, a camouflage pattern comprises at least one non-distorted layer and at least one distorted layer. In some embodiments, at least one image or layer comprises a reduced level of opacity. In some embodiments, multiple layers are each provided at an opacity of less than 100%, wherein the opacity of one layer is different from an opacity of another layer.

In some embodiments, a camouflage pattern comprises a first image having 100% opacity and a second image, wherein at least a portion of the second image overlays the first image and at least a portion of the second image is provided at an opacity of less than the opacity of the first image. In some embodiments, at least the portions of the second image that overlay the first image are provided at a reduced level of opacity.

In some embodiments, a camouflage pattern comprises a first layer depicting a first image having 100% opacity. The camouflage pattern further comprises a second layer depicting a second image. The second layer overlays the first layer such that at least a portion of the second image overlays a portion of the first image. At least a portion of the second image is provided at an opacity of less than the opacity of the first image. In some embodiments, at least the portions of the second image that overlay the first image are provided at a reduced level of opacity.

In some embodiments, portions of reduced opacity can be considered semi-transparent.

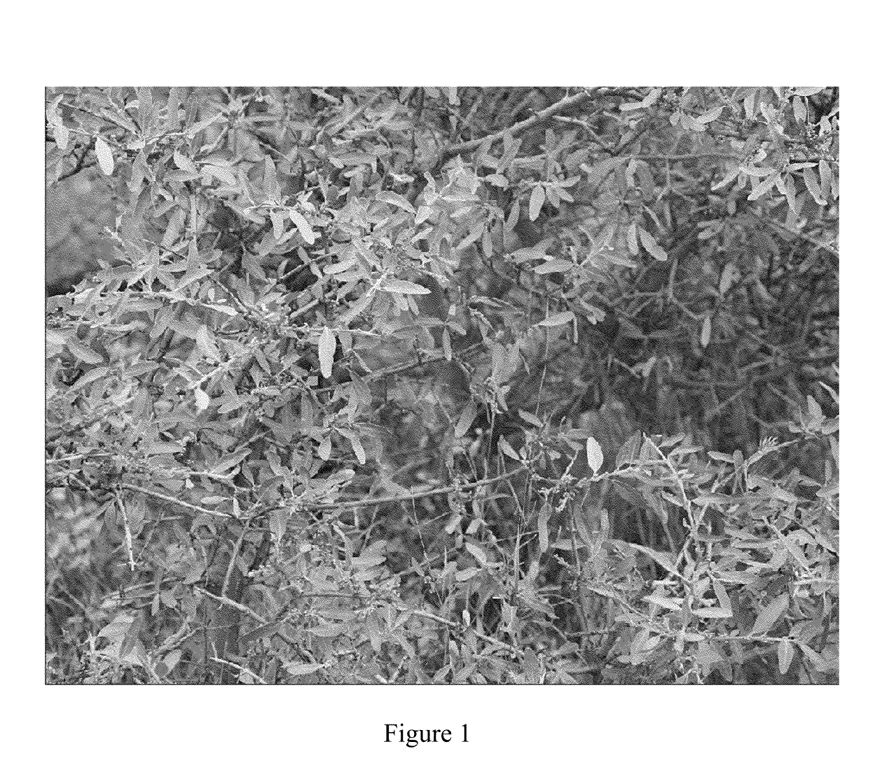

FIG. 1 shows an image that is suitable to be used as a layer, or a portion of a layer, for a camouflage pattern. The image represents a captured image, such as a digital photograph. The image depicts brush, such as a growth of bushes and/or shrubs, which are often encountered close to the ground, or between the ground and eye-level. An ordinary observer standing on the ground, viewing the image of FIG. 1 from a vantage point at eye level would generally look either horizontal or at a downward viewing direction (e.g. at an angle below horizontal).

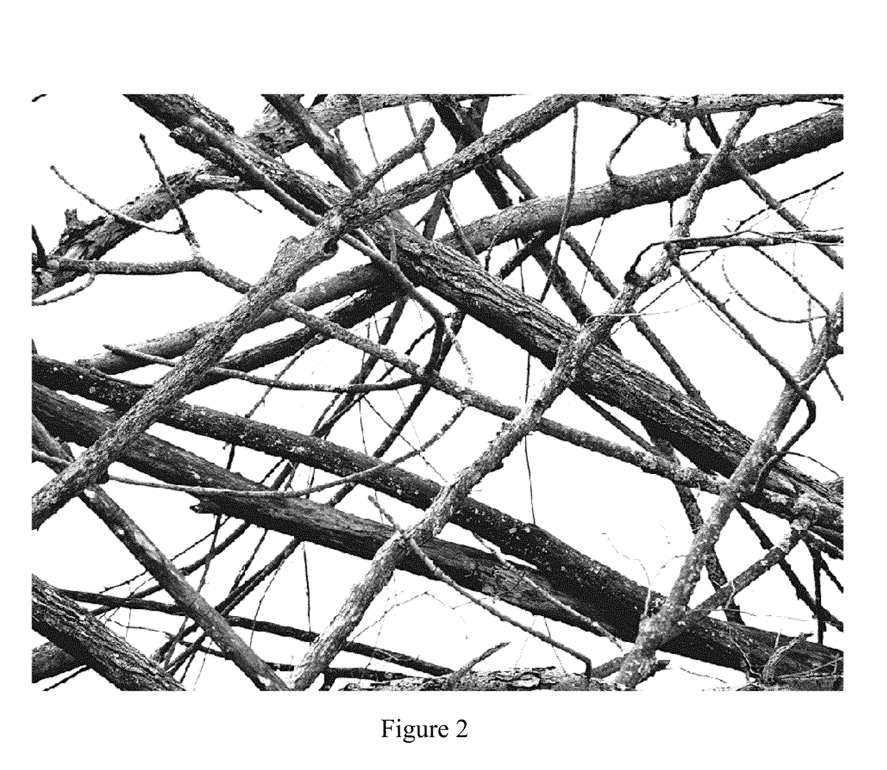

FIG. 2 shows an image that is suitable to be used as a layer, or a portion of a layer, for a camouflage pattern. The image represents a captured image, such as a digital photograph. The image depicts leafless branches, such as tree branches, with open sky in the background. An ordinary observer standing on the ground, viewing the image of FIG. 2 from the same vantage point as that of viewing FIG. 1, would generally look in an upward viewing direction (e.g. at an angle above horizontal). Thus, from the particular vantage point, the viewing angle required to view FIG. 1 is different from the viewing angle required to view FIG. 2, and an ordinary observer would not typically see the images depicted in FIGS. 1 and 2 from a single viewing direction.

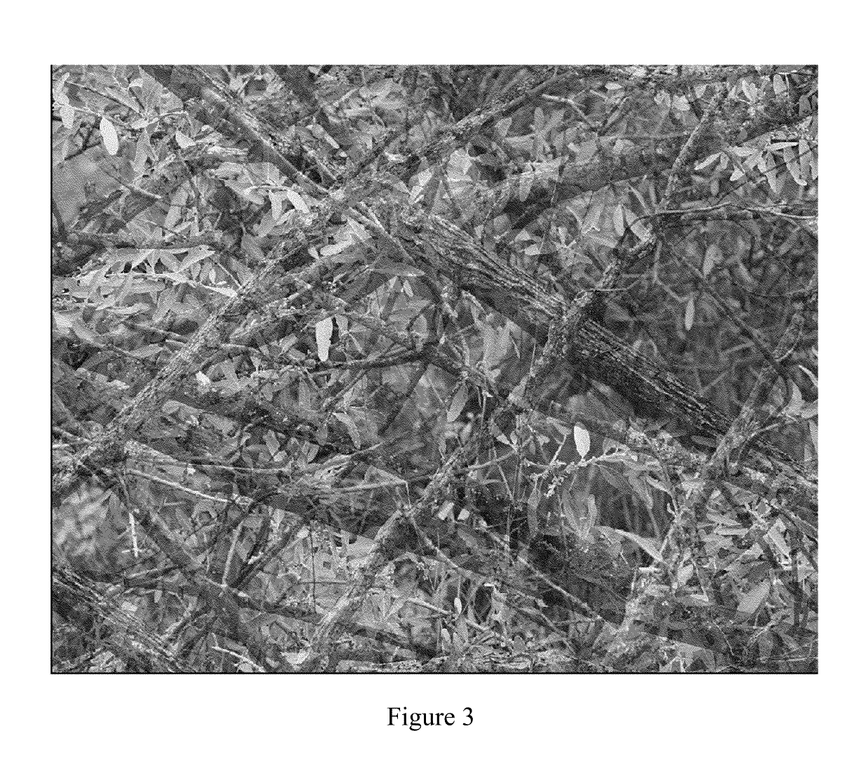

FIG. 3 shows an embodiment of a camouflage pattern that comprises the images shown in FIGS. 1 and 2. The image of FIG. 1 comprises a first layer and the image of FIG. 2 comprises a second layer. The image of FIG. 2 is oriented to overlay the image of FIG. 1. The first layer is provided at 100% opacity, and the second layer is provided at a reduced level of opacity. The specific opacity level can be chosen based upon the desired visual effect. As show in FIG. 3, the image of FIG. 2 is provided at 43% opacity, which allows the both the first and second layers to be visible, while portions of the first layer are visible through the image of the second layer.

The camouflage pattern shown in FIG. 3 tends to cause confusion because an observer does not typically view overlayed images at reduced opacity in nature. Further, the combination of views from differing observation angles in the various images or layers of the camouflage pattern helps to ensure that the pattern depicted would not be encountered in nature.

In various embodiments, any layer can be provided at any suitable level of opacity. Various embodiments that comprise similar image layers but different levels of opacity will achieve camouflage patterns having different visual effects.

In various embodiments, any image or layer in a camouflage pattern can be provided in color, grayscale or black and white, or any suitable combination thereof.

Images or layers are reduced in opacity and overlayed using any suitable method, such as a computer and image processing software.

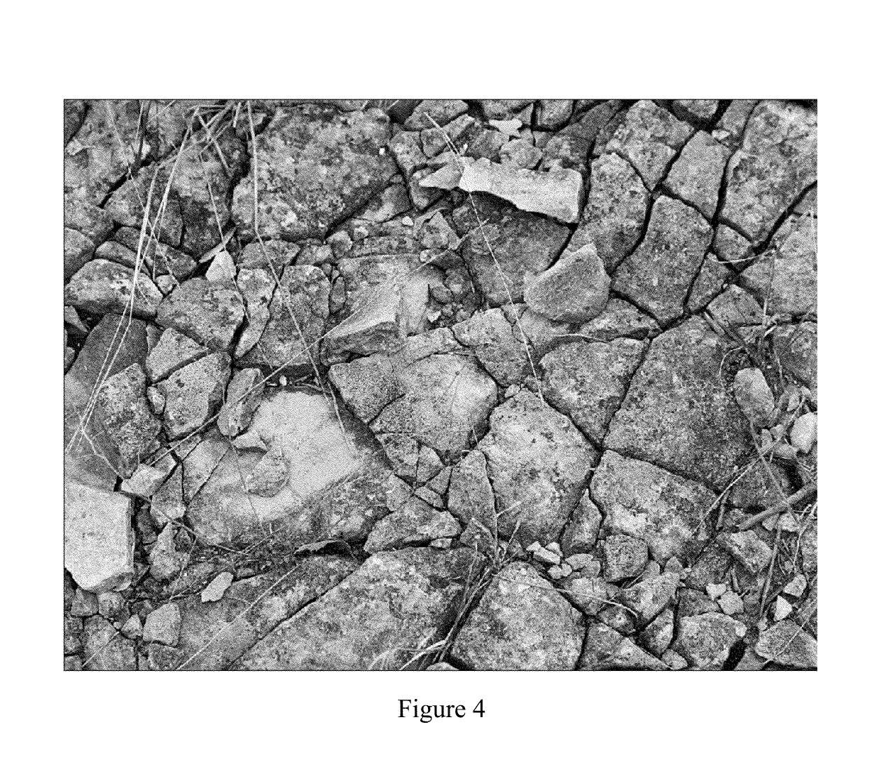

FIG. 4 shows an image that is suitable to be used as a layer, or a portion of a layer, for a camouflage pattern. The image represents a captured image, such as a digital photograph. The image depicts a rocky ground scenery. An ordinary observer standing on the ground, viewing the image of FIG. 4 from a vantage point at eye level would generally look in a downward viewing direction (e.g. at an angle below horizontal and potentially straight down, orthogonal to horizontal).

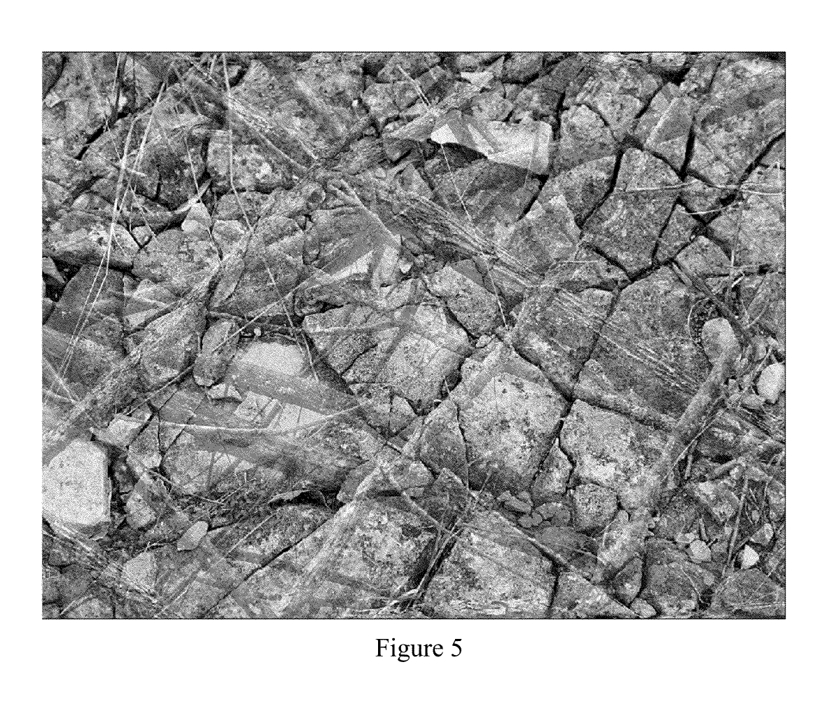

FIG. 5 shows an embodiment of a camouflage pattern that comprises the images shown in FIGS. 4 and 2. The image of FIG. 4 comprises a first layer and the image of FIG. 2 comprises a second layer. The image of FIG. 2 is oriented to overlay the image of FIG. 4. The first layer is provided at 100% opacity, and the second layer is provided at a reduced level of opacity. The specific opacity level can be chosen based upon the desired visual effect. As show in FIG. 5, the image of FIG. 2 is provided at 47% opacity, which allows the both the first and second layers to be visible, while portions of the first layer are visible through the image of the second layer.

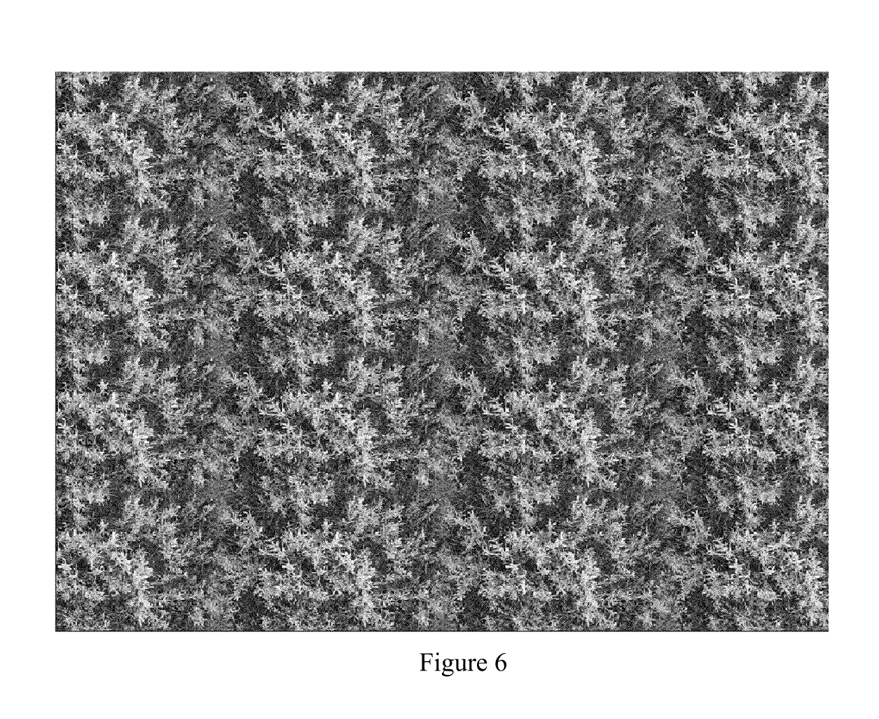

FIG. 6 shows an image that is suitable to be used as a layer, or a portion of a layer, for a camouflage pattern. The image depicts vegetation, such as grass or sage, which is often encountered close to the ground. An ordinary observer standing on the ground, viewing the image of FIG. 6 from a vantage point at eye level would generally look in a downward viewing direction (e.g. at an angle below horizontal and potentially straight down, orthogonal to horizontal).

FIG. 6 comprises a tiled image, wherein a particular image is repeated in the Figure.

In some embodiments, a layer comprises a repeated image. In some embodiments, the orientation of repeated images within a layer are similar to one another. In some embodiments, the orientation of various repeated images within a layer are different from one another. In some embodiments, repeated images within a layer can have variations from one another in size, color, orientation, etc.

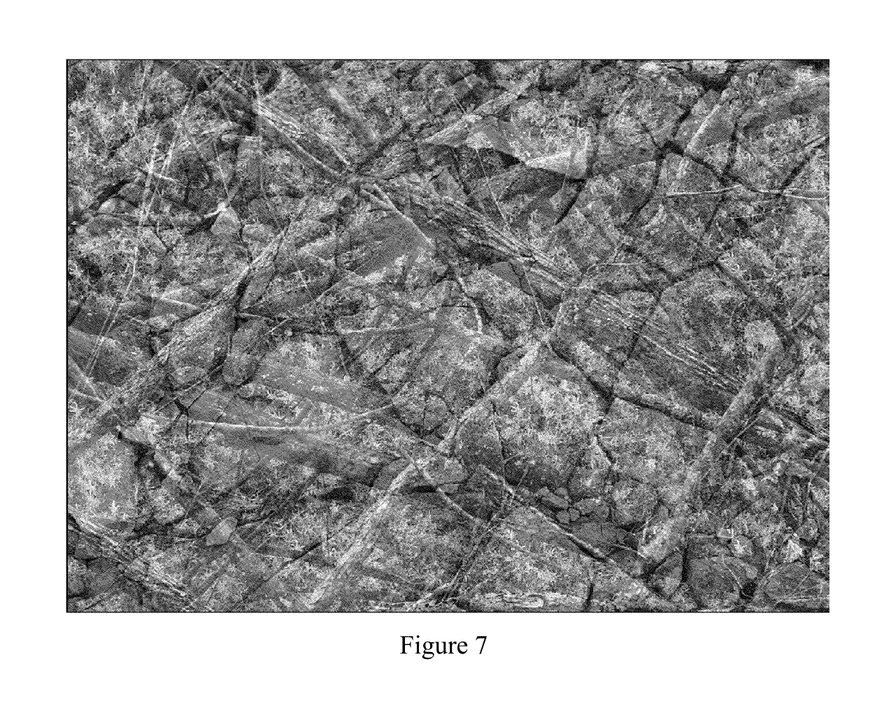

FIG. 7 shows a camouflage pattern comprising the images shown in FIGS. 6, 2 and 4. A first layer comprises the image shown in FIG. 6 at 100% opacity. A second layer comprises the image shown in FIG. 2 at a lower level of opacity, specifically at 90% opacity. A third layer comprises the image shown in FIG. 4 at an opacity level that is lower than the second layer. As shown, the third layer is provided at 50% opacity. The pattern shown in FIG. 7 represents images not ordinarily found in nature.

In a camouflage pattern, any layer can be provided at any suitable level of opacity. In some embodiments, multiple layers can each be provided at similar opacity levels. In some embodiments, each layer is provided at an opacity level different from all other layers. Layers having an opacity of less than 100% can have any suitable opacity. In some embodiments, a layer comprises an opacity level ranging from 95% to 5%. In some embodiments, a layer comprises an opacity level ranging from 90% to 10%. In some embodiments, a layer comprises an opacity level ranging from 80% to 20%. In some embodiments, a layer comprises an opacity level ranging from 60% to 40%. Varying the specific level of opacity will change the resulting camouflage pattern. Depending upon the content of images/layers, the specific opacity levels of each layer can be selected to provide the desired camouflage pattern effects.

Alternative embodiments may contain any variety of images, including natural scenery, captured images, created images, etc. Desirably, the images are provided in multiple layers for manipulation and overlay to provide a final image containing a grouping of recognizable natural objects that forms a pattern not encountered in nature.

In some embodiments, a first layer depicts an image viewed from a first vantage point, and a second layer depicts an image viewed from a second vantage point. In some embodiments, a viewing angle from the first vantage point is similar to a viewing angle from the second vantage point.

The above disclosure is intended to be illustrative and not exhaustive. This description will suggest many variations and alternatives to one of ordinary skill in this field of art. All these alternatives and variations are intended to be included within the scope of the claims where the term “comprising” means “including, but not limited to.” Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

1. A camouflage comprising:
a first image layer provided at a predetermined opacity; and
a second image layer provided at a lower opacity than the first layer, wherein the second image layer overlays the first image layer.

2. The camouflage of claim 1, wherein the predetermined opacity of the first image layer is 100%.

3. The camouflage of claim 2, wherein the opacity of the second image layer is 90% or less.

4. The camouflage of claim 1, wherein the predetermined opacity of the first image layer is less than 100%.

5. The camouflage of claim 1, wherein the first image layer comprises a view visible from a vantage point at a first viewing angle, and the second image layer comprises a view visible from said vantage point at a second viewing angle different from said first viewing angle.

6. The camouflage of claim 5, wherein said first viewing angle is below horizontal and said second viewing angle is above horizontal.

7. The camouflage of claim 1, wherein the first image layer comprises an image of ground and the second image layer comprises an image of tree branches.

8. The camouflage of claim 7, wherein the first image layer is provided at 100% opacity and the second image layer is provided at an opacity ranging from 60%-40%.

9. The camouflage of claim 1, further comprising a third image layer provided at a lower opacity than the second image layer, wherein the third image layer overlays the second image layer.

10. A camouflage comprising:
a plurality of images captured via photography of natural environments, the images comprising:
a first image forming a base layer of said camouflage, said base layer provided at 100% opacity; and
a second image forming a second layer of said camouflage, said second layer overlaying said base layer, said second layer provided at an opacity level between 20% and 80%.

11. The camouflage of claim 10, further comprising a third image forming a third layer, said third layer overlaying said second layer, said third layer provided at an opacity level between 20% and 80%.

12. The camouflage of claim 11, further comprising a fourth image forming a fourth layer, said fourth layer overlaying said third layer, said fourth layer provided at an opacity level between 20% and 80%.

13. The camouflage of claim 10, wherein a viewing direction for the first image differs from a viewing direction the second image.

14. The camouflage of claim 13, wherein a viewing direction for the first image differs from a viewing direction the third image.

15. The camouflage of claim 10, wherein a vantage point for viewing the first image differs from a vantage point for viewing the second image.

16. A method comprising:
providing a first image layer at a predetermined opacity;
providing a second image layer at a lower opacity than the first image layer; and
combining said first image layer and said second image layer to form a camouflage pattern.

17. The method of claim 16, wherein providing a first image layer comprises capturing said first image using a camera.

18. The method of claim 16, further comprising providing a third image layer at a lower opacity than the second image layer and combining said third image layer with said first and second image layers.
